(19) United States
(12) Patent Application Publication
(10) Pub. No.: US 2022/0261201 A1
(43) Pub. Date: Aug. 18, 2022

(54) COMPUTER-READABLE RECORDING MEDIUM STORING DISPLAY CONTROL PROGRAM, DISPLAY CONTROL DEVICE, AND DISPLAY CONTROL METHOD

(71) Applicant: FUJITSU LIMITED, Kawasaki-shi (JP)

(72) Inventors: Taku Sasaki, Setagaya (JP); Akihiro Takahashi, Kawasaki (JP); KEIICHI KOZUTA, Kawasaki (JP); Tetsuya Okano, Setagaya (JP)

(73) Assignee: FUJITSU LIMITED, Kawasaki-shi (JP)

(21) Appl. No.: 17/542,424

(22) Filed: Dec. 5, 2021

(30) Foreign Application Priority Data
Feb. 18, 2021 (JP) 2021-024537

(51) Int. Cl. G06F 3/14; G06V 40/20; G06V 40/18; G10L 25/63; G10L 17/06; G06Q 10/10

(52) U.S. Cl. CPC G06F 3/14; G06V 40/20; G06Q 10/1095; G10L 25/63; G10L 17/06; G06V 40/18

(57) ABSTRACT

A non-transitory computer-readable recording medium stores a display control program for causing a computer to execute a process including: identifying, from voice information of a participant of a conference or image information of the conference stored in a storage unit, a speaking partner of a remark to be recorded in minutes generated on a basis of the voice information; and displaying the remark to be recorded in the minutes and a relationship between a speaker who has made the remark and the participant other than the speaker in conjunction with each other.

### CROSS-REFERENCE TO RELATED APPLICATION

This application is based upon and claims the benefit of priority of the prior Japanese Patent Application No. 2021-24537, filed on Feb. 18, 2021, the entire contents of which are incorporated herein by reference.

### FIELD

The embodiments discussed herein are related to a display control program, a display control device, and a display control method.

### BACKGROUND

In recent years, a technique of recording a state of an in-house meeting and supporting the meeting using the recorded data has been developed.

As a related technique, for example, a technique in which a line of sight of a speaker in a conference is detected, an image obtained by capturing an object visually recognized by the speaker in the line-of-sight direction is obtained, and the obtained image is displayed on a display device provided for each attendee of the conference has been proposed.

Japanese Laid-open Patent Publication No. 2005-124160 is disclosed as related art.

### SUMMARY

According to an aspect of the embodiments, A non-transitory computer-readable recording medium stores a display control program for causing a computer to execute a process including: identifying, from voice information of a participant of a conference or image information of the conference stored in a storage unit, a speaking partner of a remark to be recorded in minutes generated on a basis of the voice information; and displaying the remark to be recorded in the minutes and a relationship between a speaker who has made the remark and the participant other than the speaker in conjunction with each other. The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary display control system according to a first embodiment;

FIG. 2 is a diagram illustrating an exemplary display control system according to a second embodiment;

FIG. 3 is a diagram illustrating exemplary functional blocks of a server device;

FIG. 4 is a diagram illustrating an exemplary hardware configuration of the server device;

FIG. 5 is a diagram illustrating an exemplary employee management information table;

FIG. 6 is a diagram illustrating an exemplary participant information table;

FIG. 7 is a diagram illustrating an exemplary remark content information table;

FIG. 8 is a diagram illustrating an exemplary remark type information table;

FIG. 9 is a diagram illustrating an exemplary speaking direction information table;

FIG. 10 is a diagram illustrating an exemplary satisfaction level information table;

FIG. 11 is a diagram illustrating an exemplary emotion point table;

FIG. 12 is a diagram illustrating an exemplary interest level information table;

FIG. 13 is a diagram illustrating an exemplary word count table;

FIG. 14 is a diagram illustrating an exemplary important word table;

FIG. 15 is a flowchart illustrating exemplary overall operation of the display control system;

FIG. 16 is a flowchart illustrating exemplary operation of a participant determination process;

FIG. 17 is a diagram for explaining an example of the participant determination process;

FIG. 18 is a flowchart illustrating exemplary operation of a remark type determination process;

FIG. 19 is a diagram for explaining an example of the remark type determination process;

FIG. 20 is a flowchart illustrating exemplary operation of a speaker determination process;

FIG. 21 is a diagram for explaining an example of the speaker determination process;

FIG. 22 is a flowchart illustrating exemplary operation of a speaking direction determination process;

FIG. 23 is a diagram for explaining an example of the speaking direction determination process;

FIG. 24 is a flowchart illustrating exemplary operation of a satisfaction level determination process;

FIG. 25 is a diagram for explaining an example of the satisfaction level determination process;

FIG. 26 is a flowchart illustrating exemplary operation of an interest level determination process;

FIG. 27 is a diagram for explaining an example of the interest level determination process;

FIG. 28 is a flowchart illustrating exemplary operation of an important word determination process;

FIG. 29 is a diagram for explaining an example of the important word determination process;

FIG. 30 is a diagram illustrating exemplary display of conference information;

FIG. 31 is a diagram illustrating exemplary display of speaking direction vectors;

FIG. 32 is a diagram illustrating exemplary interlocking display of remarks of minutes and the display of speaking direction vectors;

FIG. 33 is a diagram illustrating exemplary display of interest level vectors;

FIG. 34 is a diagram illustrating exemplary display of icon frames of satisfaction levels;

FIG. 35 is a diagram illustrating exemplary display of important word ranking; and

FIG. 36 is a diagram illustrating exemplary display of the important word ranking.

### DESCRIPTION OF EMBODIMENTS

Minutes are generated when a conference takes place. Furthermore, the generated minutes may be managed as electronic data at times. However, since the traditional minutes data merely records remarks during the conference, there is a problem that, even when a member who has not participated in the conference views the minutes data, it is difficult to understand to whom the remarks recorded in the minutes data are directed and to recognize the situation of the conference, for example.

In one aspect, the present embodiments may provide a display control program, a display control device, and a display control method for facilitating grasping a conference status based on minutes.

Hereinafter, the present embodiments will be described with reference to the drawings.

### First Embodiment

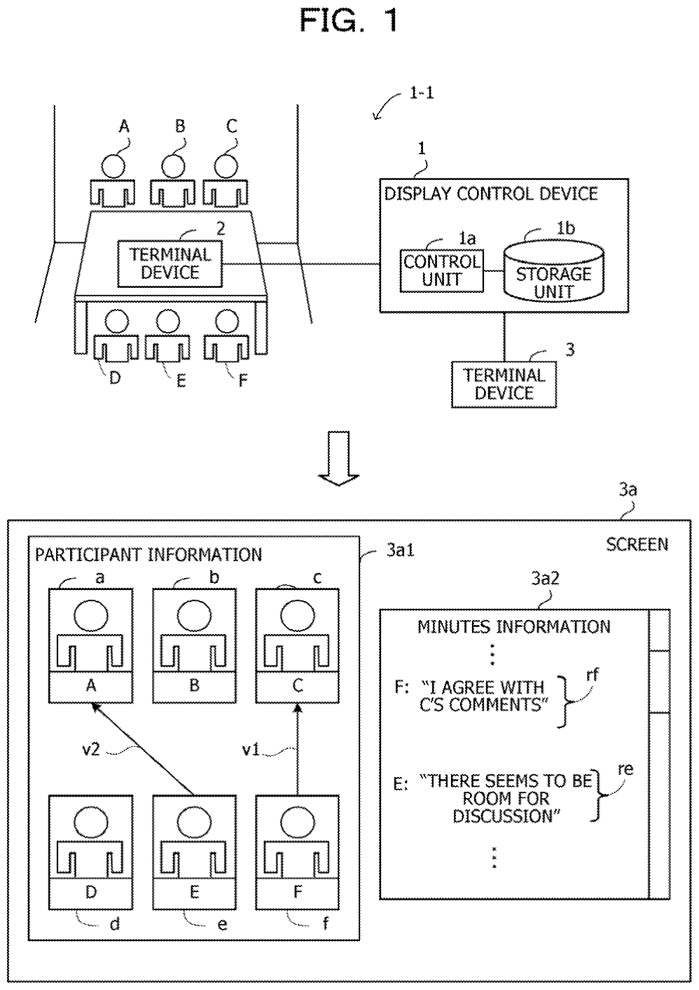

A first embodiment will be described with reference to FIG. 1. FIG. 1 is a diagram illustrating an exemplary display control system according to the first embodiment. A display control system 1-1 includes a display control device 1, a terminal device 2, and a terminal device 3.

The terminal device 2 obtains voice information and image information of participants (participants A to F) of a conference, and transmits the obtained voice information and image information to the display control device 1. The display control device 1 performs automatic generation of minutes and the like on the basis of the voice information and image information transmitted from the terminal device 2. The terminal device 3 transmits a reference request for the minutes to the display control device 1, and obtains the minutes generated by the display control device 1 to display them on a screen.

The display control device 1 includes a control unit 1a and a storage unit 1b. The storage unit 1b retains the voice information of the participants of the conference or the image information of the conference. The control unit 1a identifies, from the voice information or the image information of the conference, a speaking partner of a remark to be recorded in the minutes generated on the basis of the voice information, and displays the remark to be recorded in the minutes and a relationship between the speaker who has made the remark and participants other than the speaker in conjunction with each other.

For example, the remark to be recorded in the minutes and the speaking direction from the speaker who has made the remark to the speaking partner are linked and displayed. Note that the function of the control unit 1a is implemented by a processor (not illustrated) executing a predetermined program, the processor being included in the display control device 1.

Here, the information transmitted from the control unit 1a to the terminal device 3 is displayed on a screen 3a of the terminal device 3. The control unit 1a generates participant icons a to f obtained by symbolizing the participants A to F with a pattern, and displays, in one area of the screen 3a, participant information 3a1 including the participant icons a to f. Moreover, the control unit 1a displays minutes information (remark to be recorded in the minutes) 3a2 in another area of the screen 3a.

In FIG. 1, the control unit 1a displays a remark rf of the participant F and a remark re of the participant E in the minutes information 3a2. Furthermore, the control unit 1a identifies, from the voice information or the image information, the speaking partner of the remarks rf and re recorded in the minutes, and displays the speaking direction to the speaking partner as a relationship between the speaker and the speaking partner.

For example, in a case where the control unit 1a identifies the participant C as the speaking partner of the remark rf, an arrow v1 from the participant icon f of the participant F, who is the speaker, to the participant icon c of the participant C, who is the speaking partner, is depicted to display the speaking direction in conjunction with the display of the remark rf.

Furthermore, in a case where the control unit 1a identifies the participant A as the speaking partner of the participant E, an arrow v2 from the participant icon e of the participant E, who is the speaker, to the participant icon a of the participant A, who is the speaking partner, is depicted to display the speaking direction in conjunction with the display of the remark re. Note that, although arrow display is carried out to display the speaking direction to the speaking partner in the above descriptions as a relationship between the speaker and the speaking partner, it is also possible to display it with a line without an arrow.

As described above, in the display control system 1-1, the minutes are generated and the speaking partner of the remark to be recorded in the minutes is identified from the voice information and image information of the conference, and the remark to be recorded in the minutes and the relationship between the speaker who has made the remark and the speaking partner are displayed in conjunction with each other. This makes it possible to easily grasp the status of the conference on the basis of the minutes. Furthermore, it also becomes possible to visualize the status of the conference. In the example of FIG. 1, the speaking direction to the speaking partner of the remark to be recorded in the minutes is visualized, whereby a user is enabled to easily recognize to whom the remark in the minutes has been directed.

### Second Embodiment

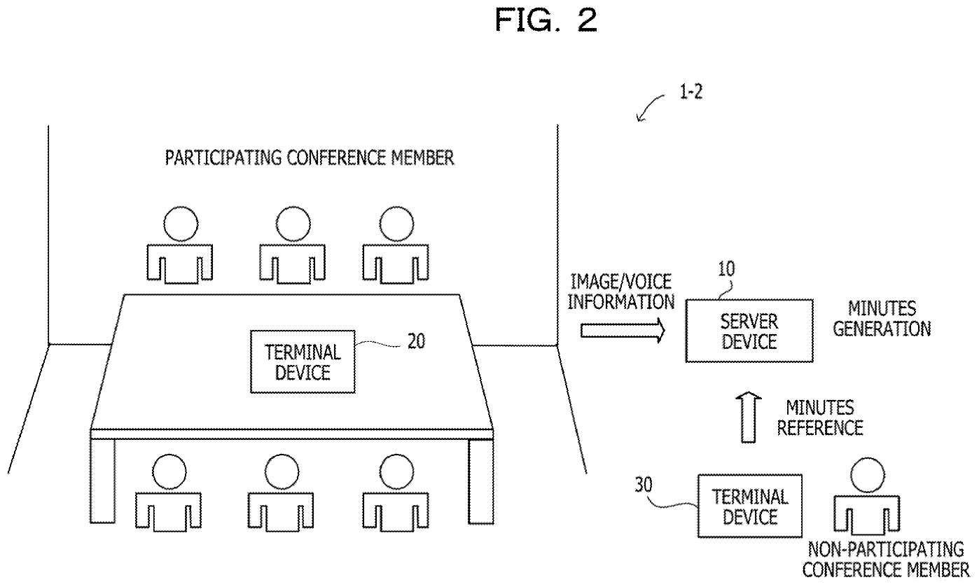

Next, a second embodiment will be described. FIG. 2 is a diagram illustrating an exemplary display control system according to a second embodiment. A display control system 1-2 includes a server device 10, a terminal device 20, and a terminal device 30. The terminal device 20 includes imaging equipment such as a camera (omnidirectional camera, etc.) and a microphone (three-dimensional sound collecting microphone, etc.), and obtains image information and voice information of members participating in a conference in a conference room. Then, the obtained image/voice information is transmitted to the server device 10 via a network (not illustrated).

The server device 10 performs automatic generation of minutes and the like on the basis of the image/voice information transmitted from the terminal device 20. For example, when the terminal device 30 receives a minutes reference request from a member who does not participate in the conference, it transmits the minutes reference request to the server device 10 via a network (not illustrated), and obtains the minutes generated by the server device 10 to display them on a screen.

<Functional Blocks>

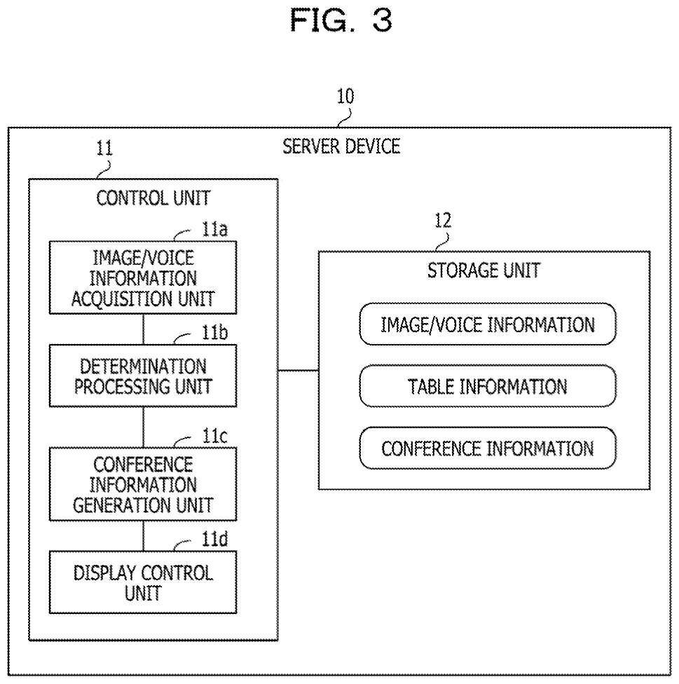

FIG. 3 is a diagram illustrating exemplary functional blocks of the server device. The server device 10 includes a control unit 11 and a storage unit 12. The control unit 11 includes an image/voice information acquisition unit 11a, a determination processing unit 11b, a conference information generation unit 11c, and a display control unit 11d.

The image/voice information acquisition unit 11a obtains image/voice information (image information and voice information) of conference participants transmitted from the terminal device 20. The determination processing unit 11b performs determination processing for identifying a conference participant, a speaker, a speaking direction, a satisfaction level, an interest level, an important word (important term and important phrase), and the like on the basis of the obtained image/voice information. Note that the details of each determination processing will be described later.

The conference information generation unit 11c generates conference information including participant information and minutes information. The participant information includes participant icons as illustrated in FIG. 1. The minutes information includes minutes and a ranking of important words. The display control unit 11d transmits the generated conference information to the terminal device 30, and performs control of display of the conference information including arrow display of a speaking direction (hereinafter referred to as vector display) and the like on a screen of the terminal device 30.

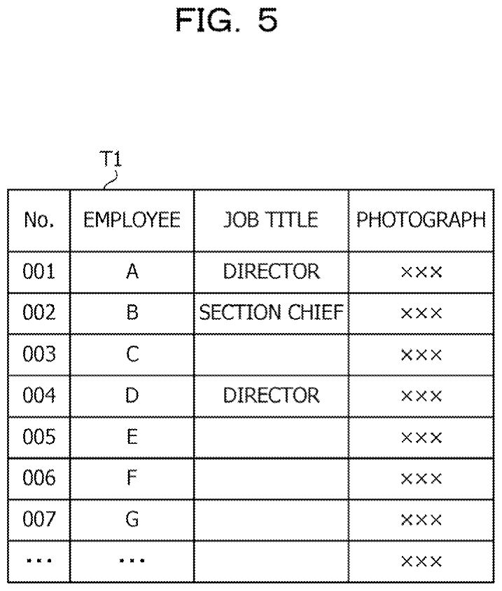

The storage unit 12 retains the image/voice information, table information, and the conference information. Note that the details of the table information will be described with reference to FIGS. 5 to 14.

<Hardware>

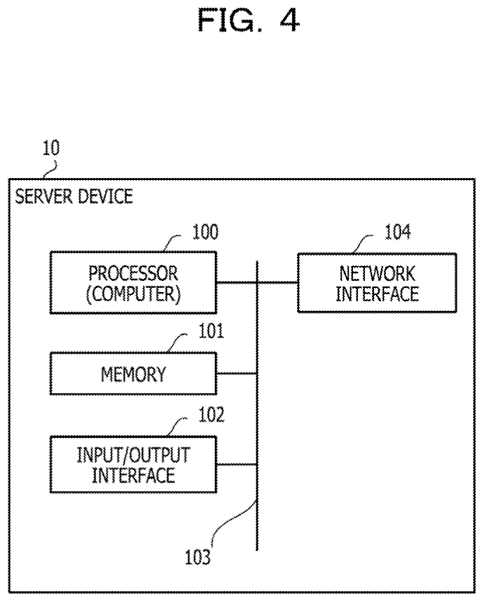

FIG. 4 is a diagram illustrating an exemplary hardware configuration of the server device. The server device 10 is entirely controlled by a processor (computer) 100. The processor 100 implements the function of the control unit 11.

A memory 101, an input/output interface 102, and a network interface 104 are connected to the processor 100 via a bus 103.

The processor 100 may also be a multiprocessor. The processor 100 is, for example, a central processing unit (CPU), a micro processing unit (MPU), a digital signal processor (DSP), an application specific integrated circuit (ASIC), or a programmable logic device (PLD). Furthermore, the processor 100 may also be a combination of two or more elements of the CPU, MPU, DSP, ASIC, and PLD.

The memory 101 implements the function of the storage unit 12, and is used as a main storage device of the server device 10. The memory 101 temporarily stores at least a part of an operating system (OS) program and an application program to be executed by the processor 100. Furthermore, the memory 101 stores various data needed for processing by the processor 100.

Furthermore, the memory 101 is also used as an auxiliary storage device of the server device 10, and stores the OS program, application program, and various data. The memory 101 may also include, as the auxiliary storage device, a semiconductor storage device such as a flash memory or a solid state drive (SSD), or a magnetic recording medium such as a hard disk drive (HDD).

Peripheral devices connected to the bus 103 include the input/output interface 102 and the network interface 104. The input/output interface 102 may be connected to an information input device such as a keyboard and a mouse, and transmits signals sent from the information input device to the processor 100.

Furthermore, the input/output interface 102 also functions as a communication interface for connecting peripheral devices. For example, the input/output interface 102 may be connected to an optical drive device that reads data recorded on an optical disk using laser light or the like. Examples of the optical disk include a Blu-ray Disc (registered trademark), a compact disc read only memory (CD-ROM), a CD-recordable/rewritable (R/RW), and the like.

Furthermore, the input/output interface 102 may be connected to a memory device or a memory reader/writer. The memory device is a recording medium having a function of communicating with the input/output interface 102. The memory reader/writer is a device that writes data in a memory card or reads data from the memory card. The memory card is a card-type recording medium.

The network interface 104 is connected to the network and performs network interface control. For example, a network interface card (NIC), a wireless local area network (LAN) card, or the like may be used as the network interface 104. The data received by the network interface 104 is output to the memory 101 and to the processor 100.

Processing functions of the server device 10 may be implemented by the hardware configuration as described above. For example, the server device 10 is capable of performing the processing according to the present embodiments by each processor 100 executing a predetermined program.

The server device 10 executes a program recorded in a computer-readable recording medium, for example, thereby implementing the processing functions according to the present embodiments. The program in which processing contents to be executed by the server device 10 are described may be recorded in various recording media.

For example, the program to be executed by the server device 10 may be stored in the auxiliary storage device. The processor 100 loads at least a part of the program in the auxiliary storage device onto the main storage device, and executes the program.

Furthermore, it also may be recorded in a portable recording medium such as an optical disk, a memory device, or a memory card. The program stored in the portable recording medium becomes executable after being installed on the auxiliary storage device under the control of the processor 100, for example. Furthermore, the processor 100 may also directly read the program from the portable recording medium to execute it.

<Table Information>

Next, the table information retained in the storage unit 12 will be described with reference to FIGS. 5 to 14. FIG. 5 is a diagram illustrating an exemplary employee management information table. An employee management information table T1 has items of a number (No.), employee (e.g., name), job title, and photograph. The employee management information table T1 registers and manages the employees, job titles, and photographs.

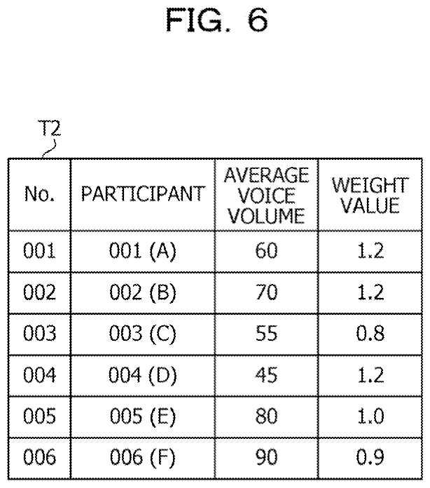

FIG. 6 is a diagram illustrating an exemplary participant information table. A participant information table T2 has items of a number, participant, average voice volume, and weight value. The participant information table T2 registers and manages the conference participants, the average values of the voice volume of respective participants, and the weight values. In the example of FIG. 6, participants A to F (A to F represent names of the participants) are registered, and Nos. 001 to 006 are added to the respective participants and registered. Note that the average voice volume is an average value of voice volume of a speaker in a predetermined speaking time period. Furthermore, the weight value is a value set in advance for weighting remarks of participants on the basis of the job title of the participant and the like. For example, the weight value is set to be higher as the job title is ranked higher.

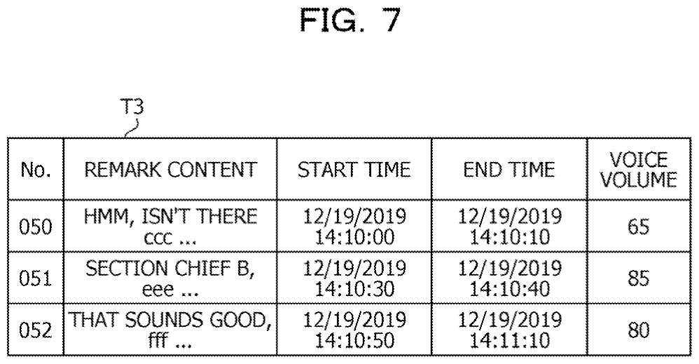

FIG. 7 is a diagram illustrating an exemplary remark content information table. A remark content information table T3 has items of a number, remark contents, start time, end time, and voice volume. The control unit 11 converts voice into text on the basis of the voice information, assigns a number to each remark of the character data converted into text, and registers and manages the remark contents spoken by the participant, the start time/end time of the remark, and the voice volume at the time when the remark is made in the remark content information table T3.

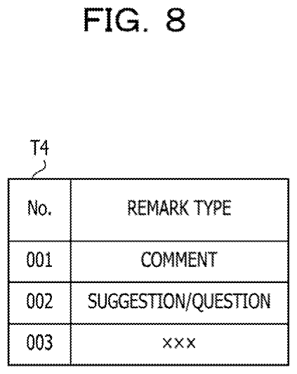

FIG. 8 is a diagram illustrating an exemplary remark type information table. The remark type information table T4 has items of a number and remark type. The remark type information table T4 is a table for registering and managing remark types of remark contents with numbers added thereto. Examples of the remark type include comment, suggestion/question, and the like.

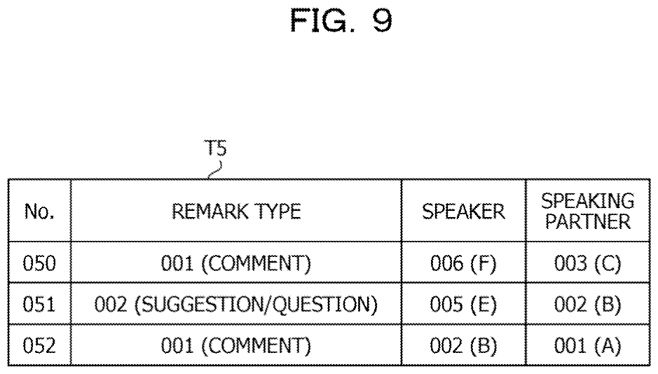

FIG. 9 is a diagram illustrating an exemplary speaking direction information table. A speaking direction information table T5 has items of a number, remark type, speaker, and speaking partner. The speaking direction information table T5 registers and manages the remark type (comment, suggestion/question, etc.) of the remark contents registered in the remark content information table T3, and the speaker and the speaking partner of the remark contents.

Note that the remark contents registered in the remark content information table T3 and the remark type registered in the speaking direction information table T5 are associated with each other using the same number. For example, a remark type of the remark content “Section chief B, eee . . . ” is a suggestion/question, and is associated with No. 051.

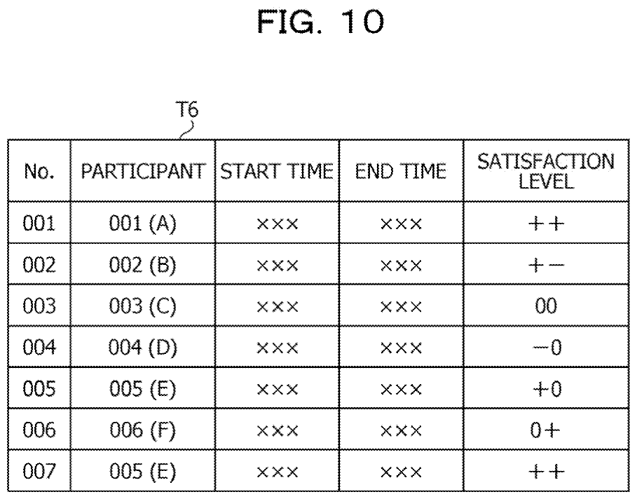

FIG. 10 is a diagram illustrating an exemplary satisfaction level information table. A satisfaction level information table T6 has items of a number, participant, start time, end time, and satisfaction level. The satisfaction level information table T6 registers and manages a parameter of a satisfaction level indicating how much the participant is convinced in the time period between the start time and the end time. Note that a positive satisfaction level indicates affirmation, a negative satisfaction level indicates denial, and zero satisfaction level indicates neither affirmation nor denial (details will be described later).

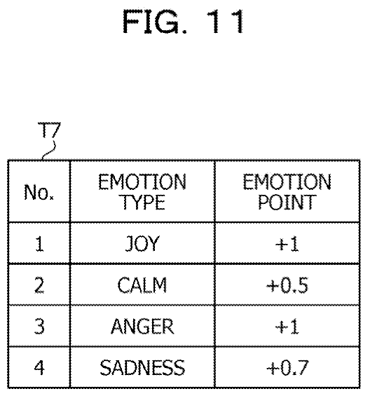

FIG. 11 is a diagram illustrating an exemplary emotion point table. An emotion point table T7 has items of a number, emotion type (joy, calm, anger, or sadness), and emotion point. A combination of the emotion type and the emotion point is registered in advance.

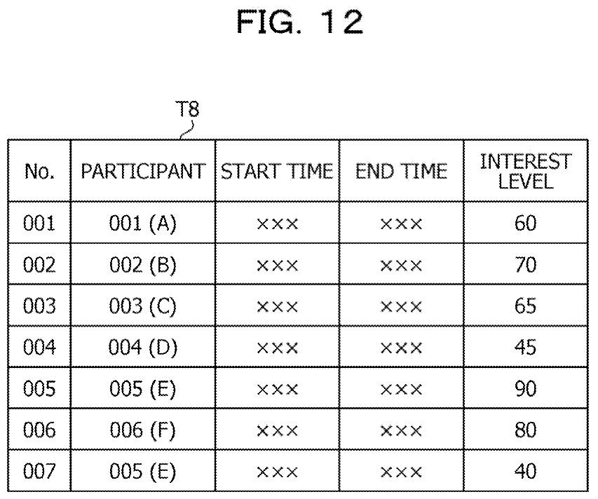

FIG. 12 is a diagram illustrating an exemplary interest level information table. An interest level information table T8 has items of a number, participant, start time, end time, and interest level. The interest level information table T8 registers and manages a digitized interest level (enthusiasm level) of the participant in the time period between the start time and the end time.

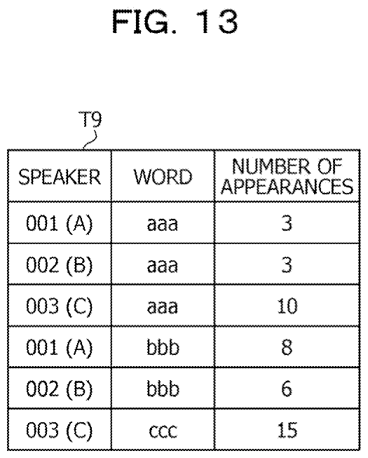

FIG. 13 is a diagram illustrating an exemplary word count table. A word count table T9 has items of a speaker, word, and the number of appearances. The word count table T9 registers and manages how many times the speaker has uttered a specific word.

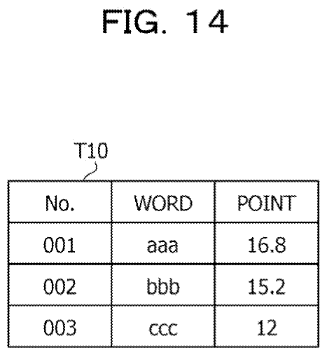

FIG. 14 is a diagram illustrating an exemplary important word table. An important word table T10 has items of a number, word, and point. The important word table T10 registers and manages points calculated for words being spoken (exemplary calculation will be described later). An importance level is higher as the point of the word is higher.

<Overall Flowchart>

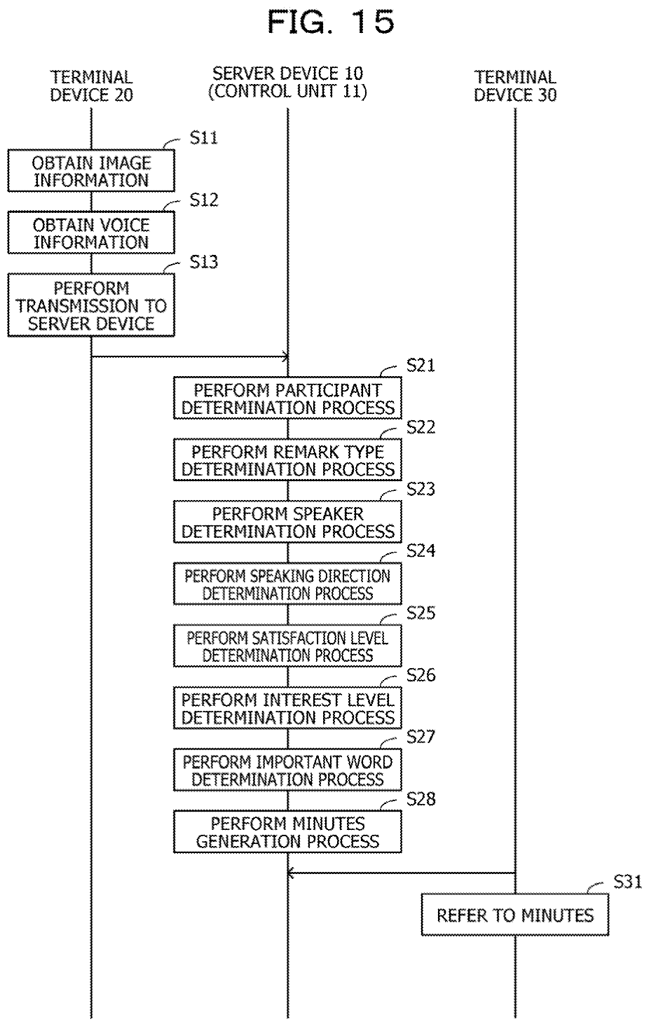

FIG. 15 is a flowchart illustrating exemplary overall operation of the display control system.

[Step S11] The terminal device 20 obtains image information of participants captured by a camera.

[Step S12] The terminal device 20 obtains voice information of the participants collected by a microphone.

[Step S13] The terminal device 20 transmits the image/voice information to the server device 10.

[Step S21] The control unit 11 of the server device 10 receives the image/voice information transmitted from the terminal device 20. Then, the control unit 11 carries out a participant determination process.

[Step S22] The control unit 11 carries out a remark type determination process.

[Step S23] The control unit 11 carries out a speaker determination process.

[Step S24] The control unit 11 carries out a speaking direction determination process.

[Step S25] The control unit 11 carries out a satisfaction level determination process.

[Step S26] The control unit 11 carries out an interest level determination process.

[Step S27] The control unit 11 carries out an important word determination process.

[Step S28] The control unit 11 carries out a minutes generation process.

[Step S31] The terminal device 30 accesses the server device 10 to carry out a minutes reference process.

<Participant Determination Process>

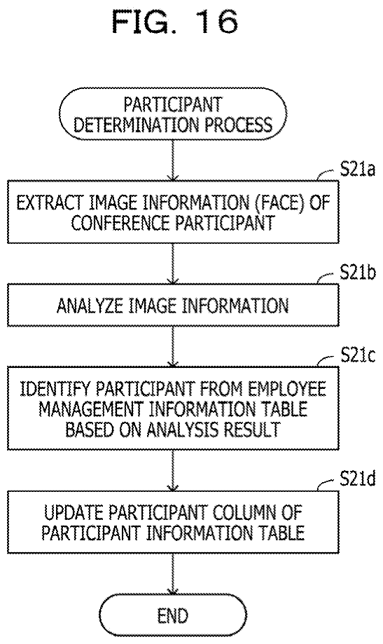

FIG. 16 is a flowchart illustrating exemplary operation of the participant determination process.

[Step S21a] The control unit 11 extracts image (face) information of the conference participants from the image information transmitted from the terminal device 20.

[Step S21b] The control unit 11 analyzes the extracted image information.

[Step S21c] The control unit 11 identifies the participants from the employee management information table T1 on the basis of the analysis result of the image information.

[Step S21d] The control unit 11 updates the participant column of the participant information table T2.

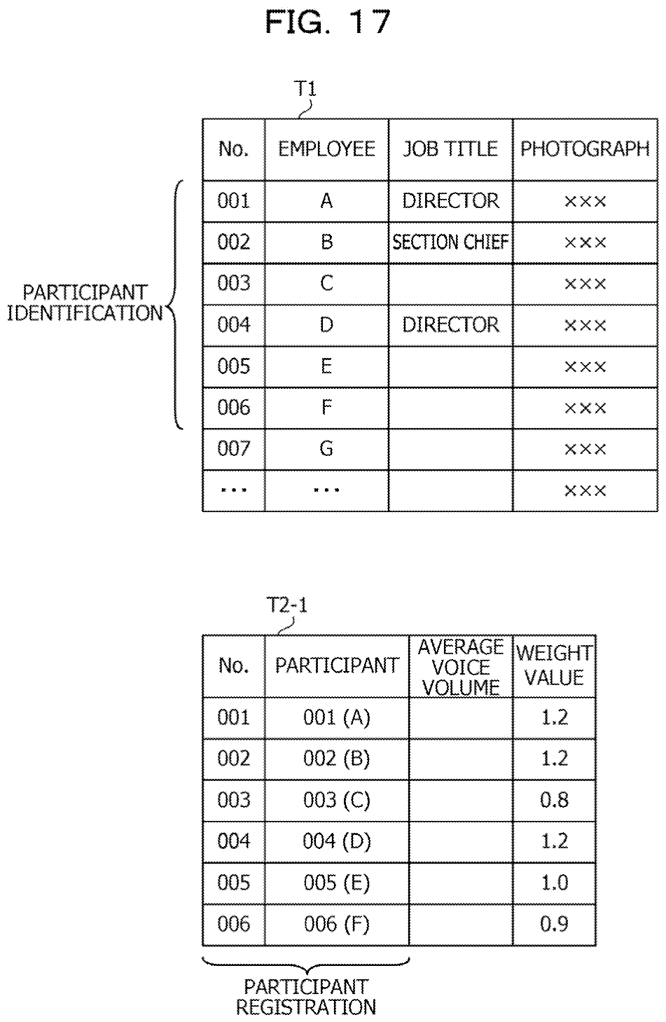

FIG. 17 is a diagram for explaining an example of the participant determination process. The control unit 11 identifies that the employees A to F in the employee management information table T1 are the participants of the conference on the basis of the processing of step S21c of FIG. 16. Then, the control unit 11 registers the identified participants A to F in a participant column of a participant information table T2-1 on the basis of the processing of step S21d of FIG. 16. According to such a participant determination process, it becomes possible to identify and manage the persons participating in the conference among the employees.

<Remark Type Determination Process>

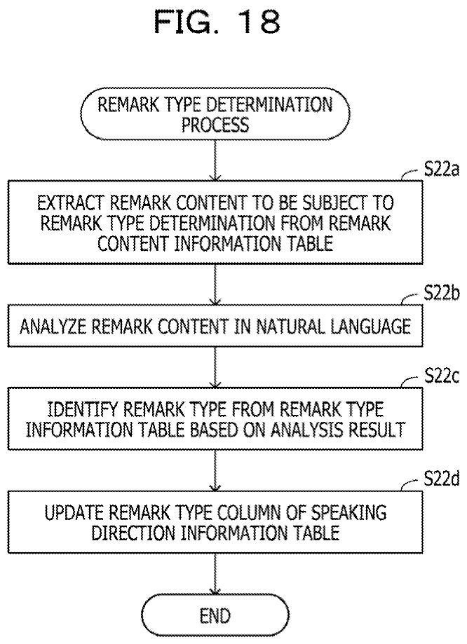

FIG. 18 is a flowchart illustrating exemplary operation of the remark type determination process.

[Step S22a] The control unit 11 extracts the remark contents to be subject to the remark type determination from the remark content information table T3.

[Step S22b] The control unit 11 analyzes the remark contents in a natural language.

[Step S22c] The control unit 11 identifies, on the basis of the analysis result, which of the remark types registered in the remark type information table T4 corresponds to the remark type of the remark contents.

[Step S22d] The control unit 11 updates the remark type column of the speaking direction information table T5.

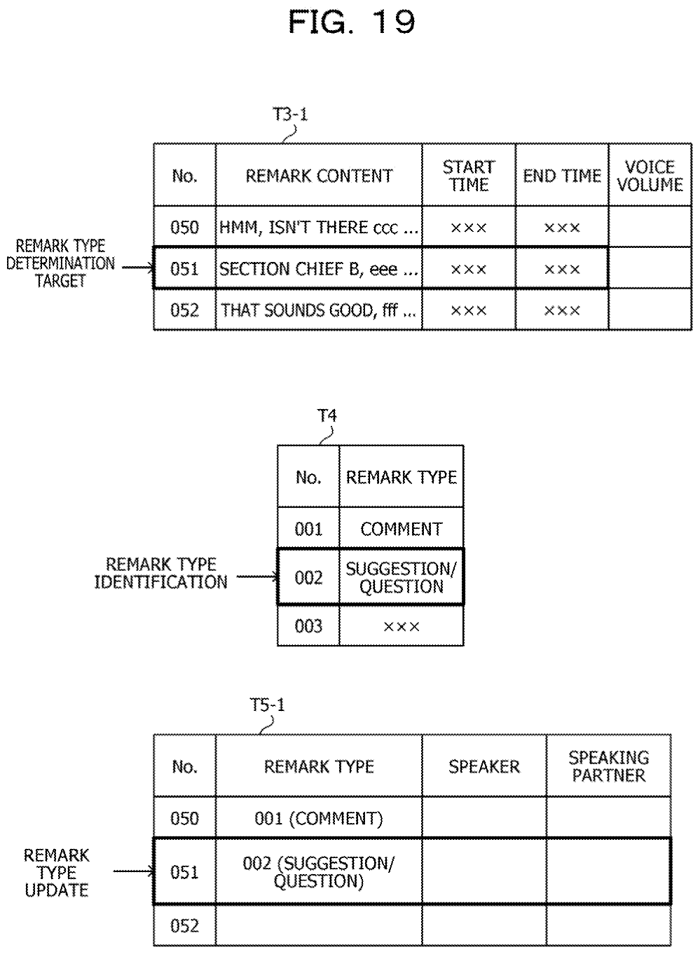

FIG. 19 is a diagram for explaining an example of the remark type determination process. The control unit 11 extracts the remark contents “Section chief B, eee . . . ” of No. 51 from a remark content information table T3-1 on the basis of the processing of step S22a of FIG. 18.

The control unit 11 identifies that the remark type of the remark content “Section chief B, eee . . . ” registered in the remark type information table T4 is a suggestion/question of No. 002 on the basis of the processing of steps S22b and S22c of FIG. 18.

Then, the control unit 11 registers, in a speaking direction information table T5-1, “002 (suggestion/question)” of No. 51 as a remark type of “Section chief B, eee . . . ” on the basis of the processing of step S22d of FIG. 18. According to such a remark type determination process, it becomes possible to identify and manage the remark type of the remark contents.

<Speaker Determination Process>

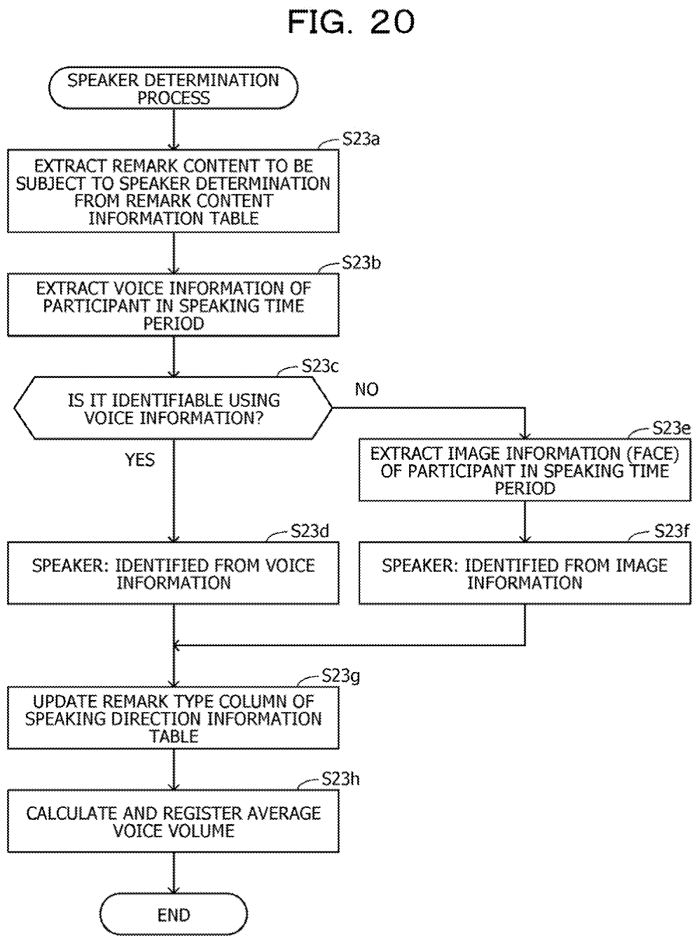

FIG. 20 is a flowchart illustrating exemplary operation of the speaker determination process.

[Step S23a] The control unit 11 extracts the remark contents to be subject to the speaker determination from the remark content information table T3.

[Step S23b] The control unit 11 extracts the voice information of the participants in the speaking time period (time period between the start time and the end time registered in the remark content information table T3).

[Step S23c] The control unit 11 determines whether or not the speaker is identifiable using the obtained voice information (e.g., it is determined from characteristics of voice, microphone directivity, etc.). The process proceeds to step S23d if it is identifiable, and the process proceeds to step S23e if it is unidentifiable.

[Step S23d] The control unit 11 identifies the speaker from the voice information. The process proceeds to step S23g.

[Step S23e] The control unit 11 obtains image information (face) of the participants in the speaking time period.

[Step S23f] The control unit 11 identifies the speaker from the obtained image information (e.g., it is determined from an image such as a moving mouth).

[Step S23g] The control unit 11 updates the remark type column of the speaking direction information table T5.

[Step S23h] After the speaker identification is complete, the control unit 11 calculates the average value of the voice volume (average voice volume) of the identified speaker in the speaking time period, and registers it in the participant information table T2.

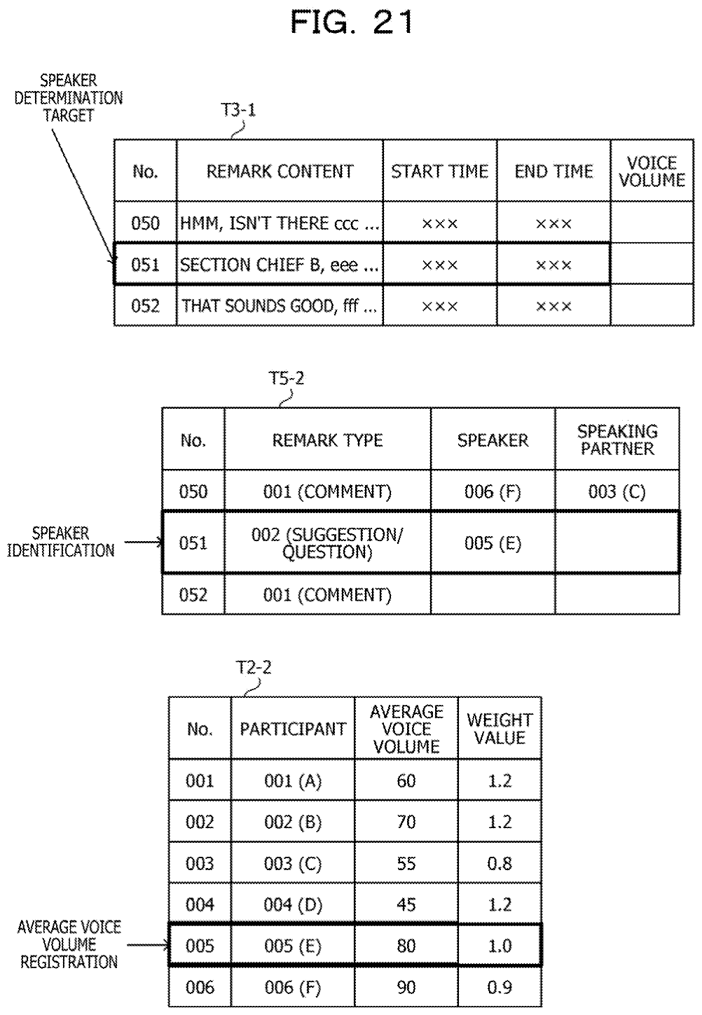

FIG. 21 is a diagram for explaining an example of the speaker determination process. The control unit 11 extracts the remark contents “Section chief B, eee . . . ” of No. 51 from the remark content information table T3-1 on the basis of the processing of step S23a of FIG. 20.

The control unit 11 identifies, on the basis of the processing of steps S23b to S23g of FIG. 20, that the remark contents of “Section chief B, eee . . . ” is the speaker (005 (E)), and registers it in a speaking direction information table T5-2.

Then, the control unit 11 calculates, on the basis of the processing of step S23h of FIG. 20, average voice volume of the speaker (005 (E)), and registers it in a participant information table T2-2. According to such a speaker determination process, it becomes possible to identify and manage the speaker.

<Speaking Direction Determination Process>

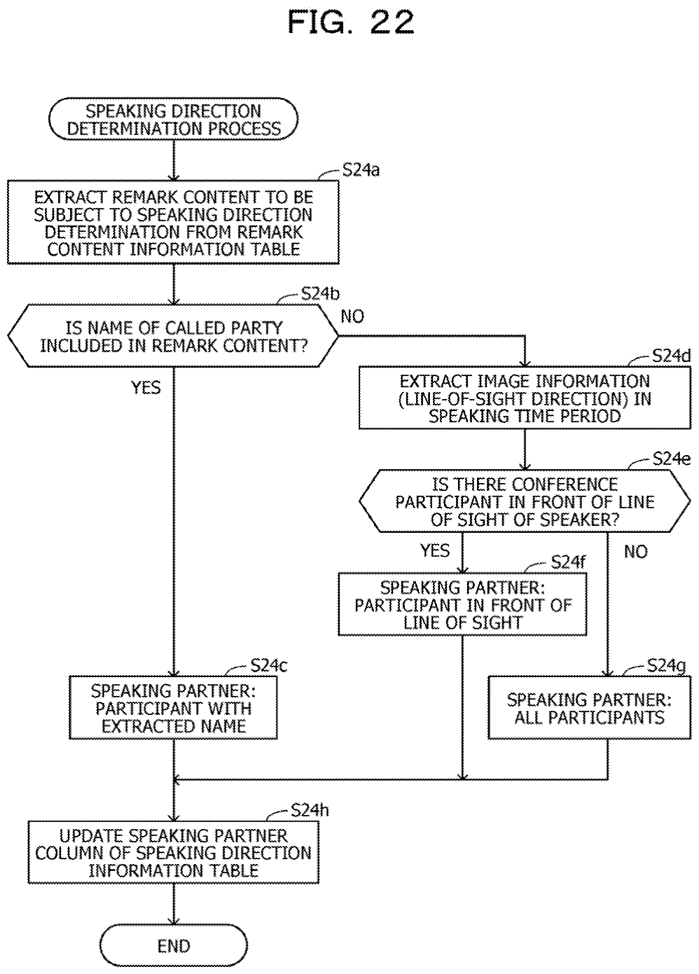

FIG. 22 is a flowchart illustrating exemplary operation of the speaking direction determination process.

[Step S24a] The control unit 11 extracts the remark contents to be subject to the speaking direction determination from the remark content information table T3.

[Step S24b] The control unit 11 determines whether or not the name of the called party is included in the extracted remark contents. The process proceeds to step S24c if the name of the called party is included, and the process proceeds to step S24d if the name of the called party is not included.

[Step S24c] The control unit 11 extracts the name of the called party, and identifies the participant with the extracted name as a speaking partner. The process proceeds to step S24h.

[Step S24d] The control unit 11 extracts the image information (line-of-sight direction) of the speaker in the speaking time period.

[Step S24e] The control unit 11 determines whether or not there is a conference participant in front of the line of sight (or face orientation) of the speaker. The process proceeds to step S24f if there is a participant, and proceeds to step S24g if there is no participant.

[Step S24f] The control unit 11 identifies the participant who is in front of the line of sight (or face orientation) of the speaker as a speaking partner.

[Step S24g] The control unit 11 identifies all the conference participants as speaking partners.

[Step S24h] The control unit 11 updates the speaking partner column of the speaking direction information table T5.

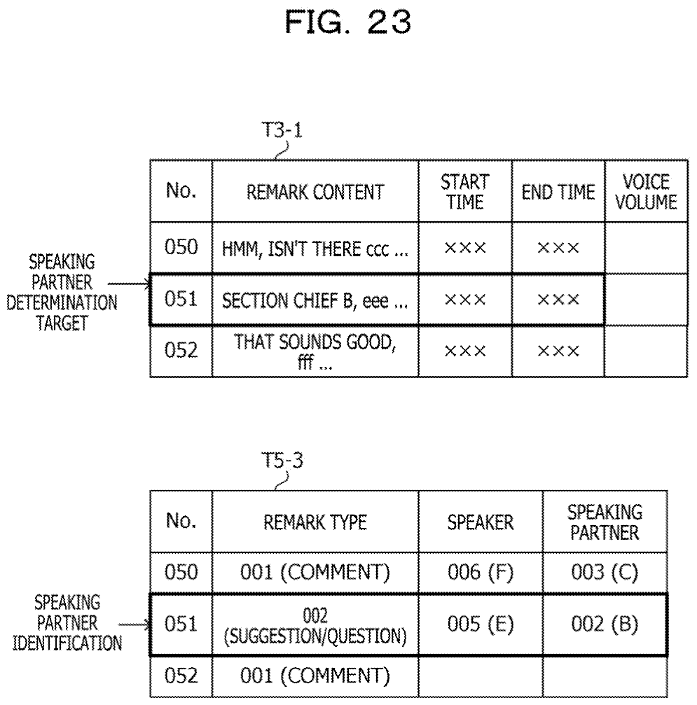

FIG. 23 is a diagram for explaining an example of the speaking direction determination process. The control unit 11 extracts the remark contents “Section chief B, eee . . . ” of No. 51 from the remark content information table T3-1 on the basis of the processing of step S24a of FIG. 22.

The control unit 11 identifies, on the basis of the processing of steps S24b to S24h of FIG. 22, that the speaking partner of the speaker (005 (E)) is a participant 002 (B), and registers it in a speaking direction information table T5-3. According to such a speaking direction determination process, it becomes possible to identify and manage the speaking partner of the speaker.

<Satisfaction Level Determination Process>

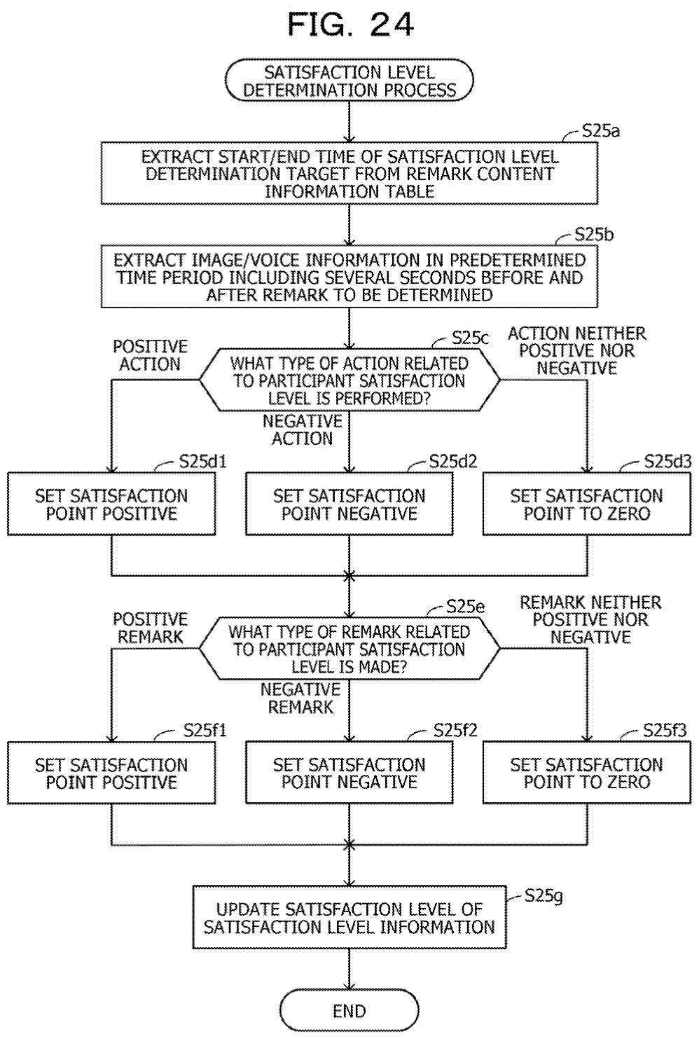

FIG. 24 is a flowchart illustrating exemplary operation of the satisfaction level determination process.

[Step S25a] The control unit 11 extracts, from the remark content information table T3, the start time and the end time of the remark contents to be subject to the participant satisfaction level determination.

[Step S25b] The control unit 11 extracts the image/voice information in a predetermined time period including several seconds before and after the extracted start time and end time.

[Step S25c] The control unit 11 determines an action related to a satisfaction level of the participant on the basis of the analysis result of the extracted image information. The process proceeds to step S25d1 if the action related to the satisfaction level is a positive action (nodding, etc.), the process proceeds to step S25d2 if the action related to the satisfaction level is a negative action (tilting the neck, etc.), and the process proceeds to step S25d3 if the action related to the satisfaction level is neither positive nor negative.

[Step S25d1] The control unit 11 sets a satisfaction point positive.

[Step S25d2] The control unit 11 sets the satisfaction point negative.

[Step S25d3] The control unit 11 sets the satisfaction point to zero.

[Step S25e] The control unit 11 determines a remark related to a satisfaction level of the participant on the basis of the analysis result of the extracted voice information. The process proceeds to step S25f1 if the remark related to the satisfaction level is a positive remark (positive statement), the process proceeds to step S25f2 if the remark related to the satisfaction level is a negative remark (negative statement), and the process proceeds to step S25f3 if the remark related to the satisfaction level is neither positive nor negative.

[Step S25f1] The control unit 11 sets the satisfaction point positive.

[Step S25f2] The control unit 11 sets the satisfaction point negative.

[Step S25f3] The control unit 11 sets the satisfaction point to zero.

[Step S25g] The control unit 11 updates the satisfaction level of the satisfaction level information table T6.

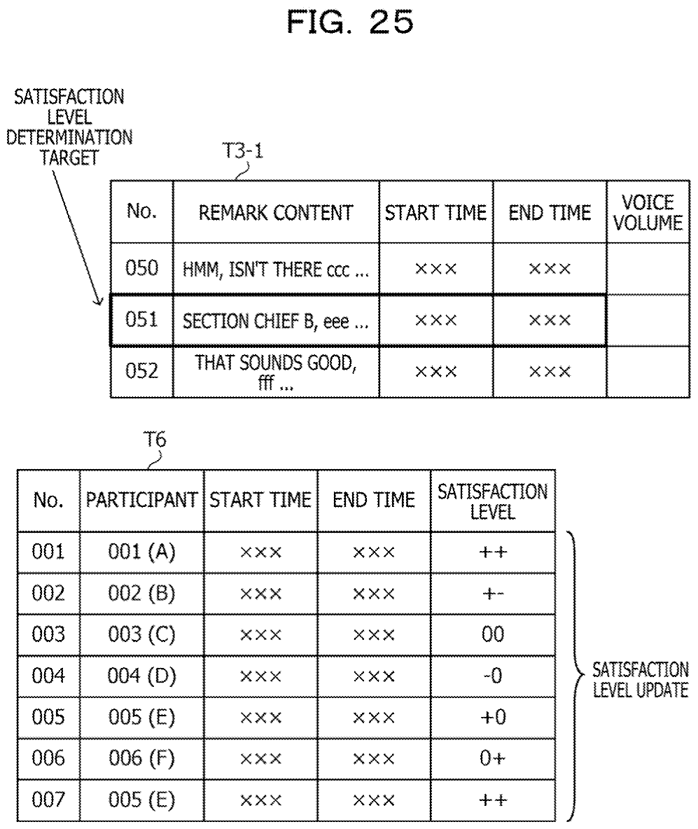

FIG. 25 is a diagram for explaining an example of the satisfaction level determination process. The control unit 11 extracts the start time and the end time of the satisfaction level determination target from the remark content information table T3-1 on the basis of the processing of step S25a of FIG. 24.

Then, on the basis of the processing of steps S25b to S25g of FIG. 24, the control unit 11 obtains the satisfaction point of the speaker and registers it in the satisfaction level information table T6. According to such a satisfaction level determination process, it becomes possible to identify and manage the satisfaction level of the speaker.

<Interest Level (Enthusiasm Level) Determination Process>

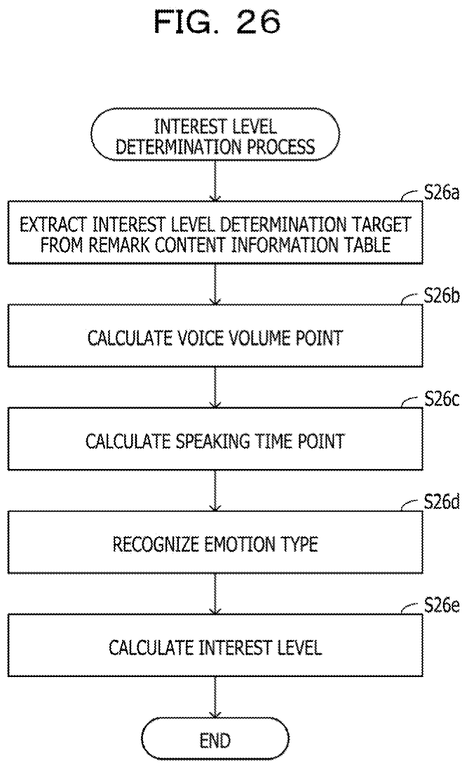

FIG. 26 is a flowchart illustrating exemplary operation of the interest level determination process.

[Step S26a] The control unit 11 extracts the remark contents to be subject to the participant interest level determination from the remark content information table T3.

[Step S26b] The control unit 11 obtains the voice information of the extracted remark contents, and calculates a point of the voice volume when the speaker has uttered the remark contents. For example, the point of the voice volume is calculated by (voice volume point)=(utterance sound pressure)−(average utterance sound pressure for each individual)×(voice volume point coefficient). Then, the control unit 11 registers the calculated voice volume in the remark content information table T3.

[Step S26c] The control unit 11 calculates a point of the speaking time (total speaking time) in which the participant has spoken in the conference. For example, the point of the speaking time is calculated by (speaking time point)=((speaking time period)−(effective speaking time))×(speaking time point coefficient).

[Step S26d] The control unit 11 performs voice emotion recognition processing of the voice information of the remark contents to determine an emotion type, and obtains an emotion point from the emotion point table T7 on the basis of the emotion type.

[Step S26e] The control unit 11 calculates an interest level on the basis of the voice volume point, speaking time point, and emotion point. For example, the interest level is calculated by (interest level)=(emotion point)×emotion coefficient×((speaking time point×0.5)+(voice volume point×0.5)). Then, the control unit 11 registers the calculated interest level in the interest level information table T8.

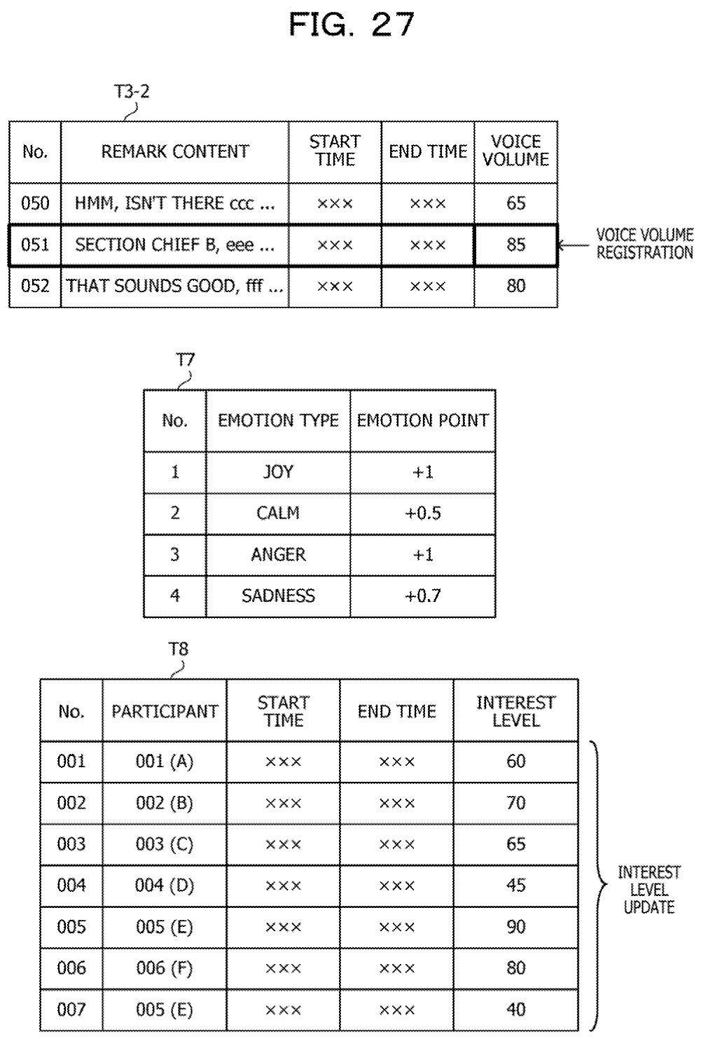

FIG. 27 is a diagram for explaining an example of the interest level determination process. The control unit 11 extracts the start time and the end time from a remark content information table T3-2 on the basis of the processing of step S26a of FIG. 26. Furthermore, it registers the calculated voice volume in the remark content information table T3-2.

On the basis of the processing of steps S26b to S26e of FIG. 26, the control unit 11 converts the interest level of the speaker into a number and registers it in the interest level information table T8 (the interest level becomes higher as the value increases). According to such an interest level determination process, it becomes possible to identify and manage the interest level of the speaker.

<Important Word Determination Process>

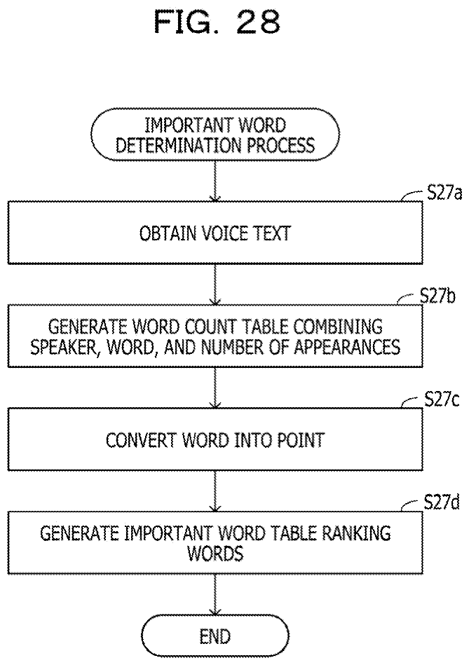

FIG. 28 is a flowchart illustrating exemplary operation of the important word determination process.

[Step S27a] The control unit 11 obtains voice text (character data) on the basis of the voice information.

[Step S27b] The control unit 11 generates, on the basis of the voice text, a word count table T9 in which a speaker, a phrase (word) spoken by the speaker, and the number of appearances of the phase spoken by the speaker are combined.

[Step S27c] The control unit 11 converts the word into a point on the basis of the weight value registered in the participant information table T2.

[Step S27d] The control unit 11 ranks words on the basis of the points generated in step S27c to generate an important word table T10.

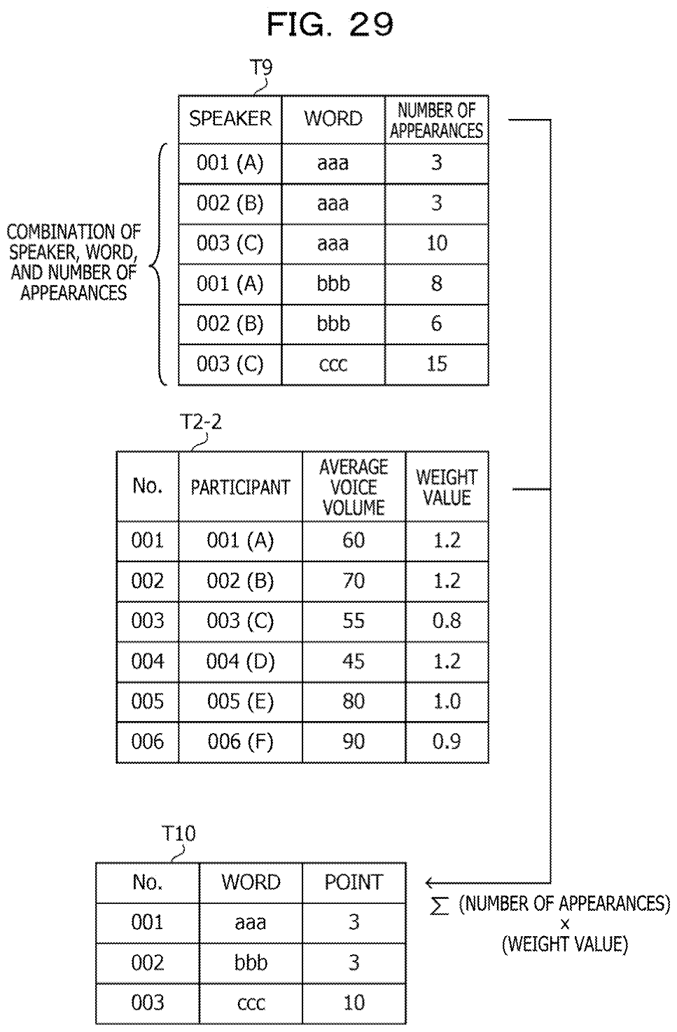

FIG. 29 is a diagram for explaining an example of the important word determination process. The control unit 11 generates the word count table T9 on the basis of the processing of step S27b of FIG. 28. The control unit 11 converts the word into a point on the basis of the processing of steps S27c and S27d of FIG. 28. The point (word point) of a predetermined word is the sum of the values calculated for respective speakers by (number of appearances of the predetermined word)×(speaker weight value).

In the example of FIG. 29, the word aaa is spoken by the speaker A three times, spoken by the speaker B three times, and spoken by the speaker C ten times according to the word count table T9, and the weight values of the speakers A, B, and C are 1.2, 1.2, and 0.8, respectively, according to the participant information table T2-2. Therefore, the point of the word aaa is (3×1.2)+(3×1.2)+(10×0.8)=15.2.

Then, the control unit 11 generates the important word table T10 in which words are associated with respective points. According to such an important word determination process, it becomes possible to identify the important word from the contents spoken in the conference to manage it.

<Exemplary Display of Conference Information>

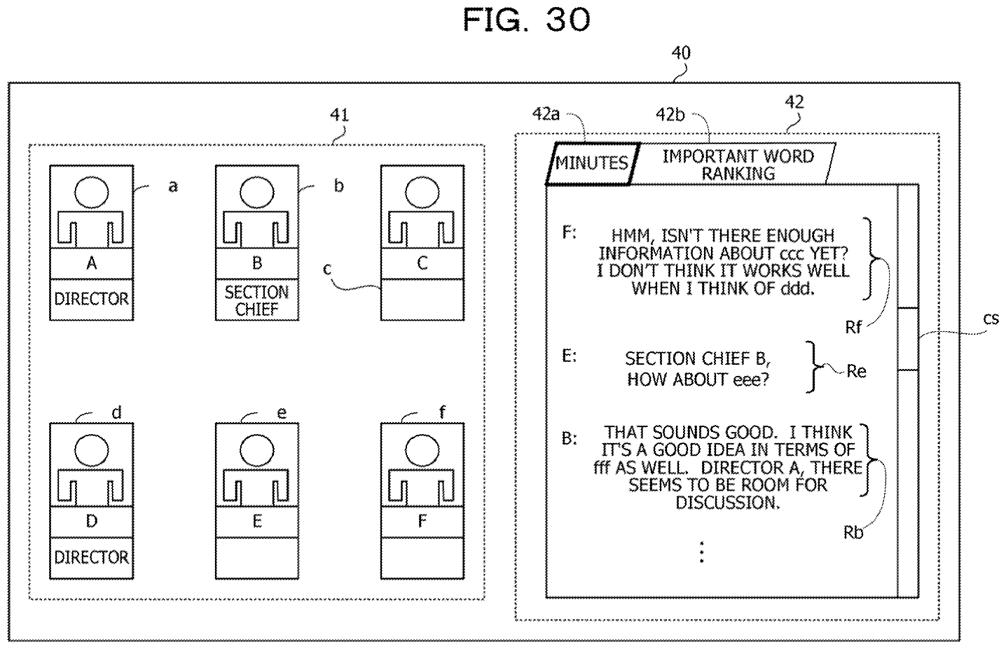

FIG. 30 is a diagram illustrating exemplary display of conference information. The server device 10 performs the processing of steps S21 to S27 of FIG. 15 as described above to generate minutes information, and transmits conference information 40 including the minutes information to the terminal device 30 on the basis of the minutes reference request from the terminal device 30. The conference information 40 transmitted from the server device 10 is displayed on the screen of the terminal device 30.

The conference information 40 includes participant information 41 and minutes information 42. The participant information 41 includes participant icons a to f. The participant icons a to f indicate, for example, an image, name, and job title of a participant. The minutes information 42 includes minutes 42a obtained by converting remark contents of participants during the conference into text, and an important word ranking 42b, which is information obtained by ranking the important words generated in step S27.

In the example of FIG. 30, participants of a certain conference are A, B, C, D, E, and F, and participant icons a to f representing the respective participants indicate an upper body photograph, name, and job title in the participant information 41.

Furthermore, the minutes 42a indicate a remark Rf “Hmm, isn't there enough information about ccc yet? I don't think it works well when I think of ddd.” of the participant F, a remark Re “Section chief B, how about eee?” of the participant E, and a remark Rb “That sounds good. I think it's a good idea in terms of fff as well. Director A, there seems to be room for discussion.” of the participant B. The remark display in the minutes 42a may be moved up and down with a cursor cs. Exemplary display of the important word ranking 42b will be described later.

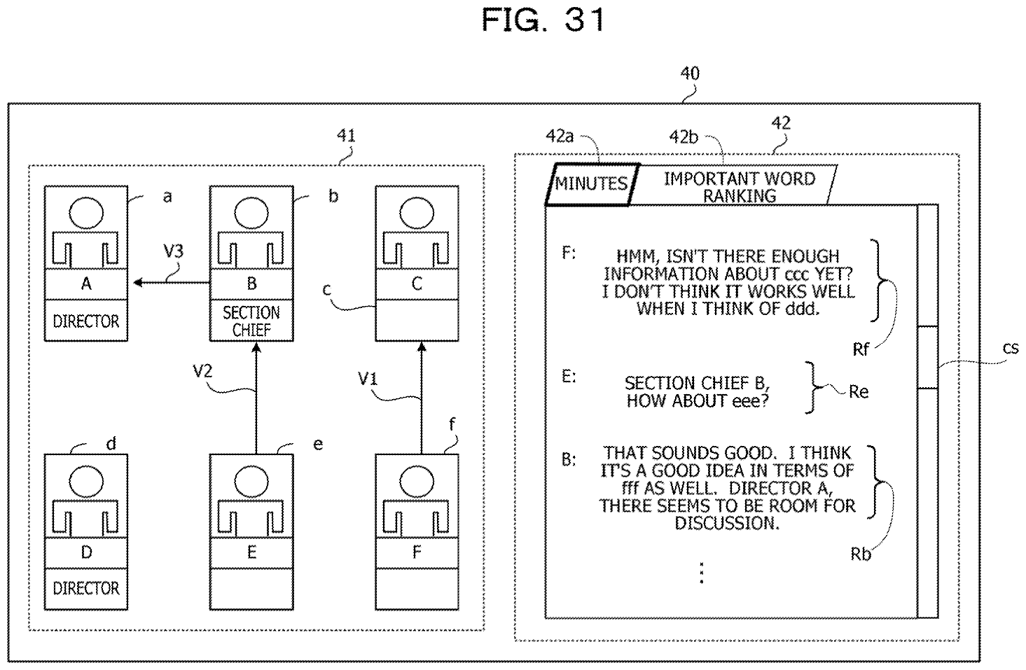

FIG. 31 is a diagram illustrating exemplary display of speaking direction vectors. The control unit 11 displays a vector of a speaking direction in conjunction with a remark indicated in the minutes 42a. In the example of FIG. 31, a vector V1 is displayed from the participant icon f toward the participant icon c. Therefore, the user who uses the terminal device 30 is enabled to easily recognize that the remark Rf of the participant F in the minutes 42a is directed to the participant C.

Moreover, a vector V2 is displayed from the participant icon e toward the participant icon b. Therefore, the user is enabled to easily recognize that the remark Re of the participant E in the minutes 42a is directed to the participant B.

Furthermore, a vector V3 is displayed from the participant icon b toward the participant icon a. Therefore, the user is enabled to easily recognize that the remark Rb of the participant B in the minutes 42a is directed to the participant A.

Note that the remark in the minutes 42a and the vector corresponding to the remark may be displayed in the same color. For example, the remark Rf of the participant F and the vector V1 are displayed in red, the remark Re of the participant E and the vector V2 are displayed in blue, and the remark Rb of the participant B and the vector V3 are displayed in yellow. As described above, with the remark and the vector indicated in the same color, it becomes possible to recognize the remark and the speaking direction more easily.

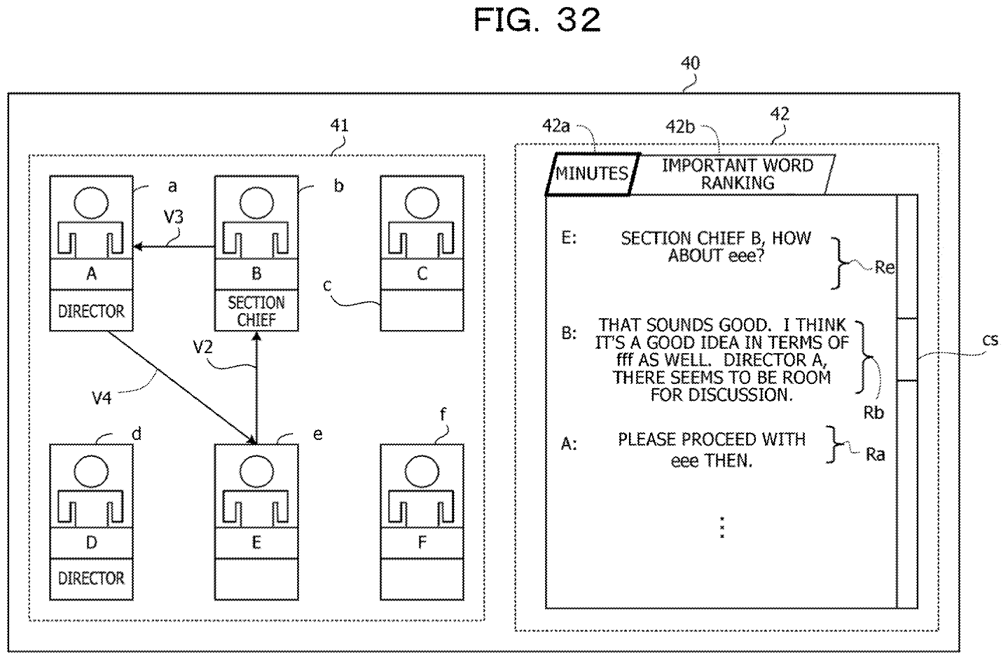

FIG. 32 is a diagram illustrating exemplary interlocking display of remarks of the minutes and the display of speaking direction vectors. When the user moves the cursor cs, the remarks in the minutes 42a transition and are displayed. Furthermore, the vector of the speaking direction is displayed in conjunction with the remark displayed in the minutes 42a.

For example, in FIG. 32, the cursor cs is moved downward so that the remark Ra transitioned from the display in FIG. 31 is newly depicted in the minutes 42a and the remark Rf in FIG. 31 has disappeared.

In the minutes 42a, the remark Re, the remark Rb, and the remark Ra are depicted. Furthermore, the speaking direction of the newly displayed remark Ra is a direction from the participant A toward the participant E.

In this case, the participant information 41 displays the vector V2 from the participant icon e toward the participant icon b, the vector V3 from the participant icon b toward the participant icon a, and a vector V4 from the participant icon a toward the participant icon e.

In this manner, the vector of the speaking direction of the remark is displayed in conjunction with the vector that transitions with the movement of the cursor cs, whereby the user is enabled to easily recognize the remark in the minutes 42a and the speaking direction of the remark.

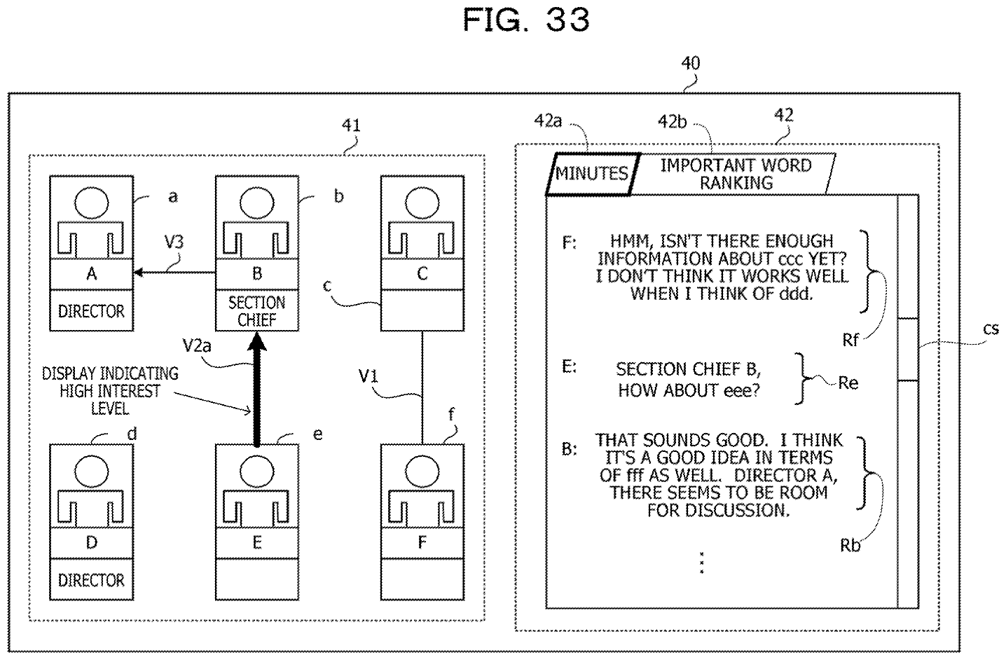

FIG. 33 is a diagram illustrating exemplary display of interest level vectors. An emphasis level of vector display indicating a speaking direction is varied according to the size of an interest point obtained from the remark of the participant. In the example of FIG. 33, the interest point of the remark of the participant E obtained by the processing of step S26 of FIG. 15 is set to a value equal to or higher than a threshold value. In this case, a line of a vector V2a from the participant icon e toward the participant icon b is emphasized (e.g., made thicker than a line of another vector) and displayed. In this manner, the emphasis level of the vector display is variably displayed according to the interest point, whereby the user is enabled to recognize the interest level of the participant easily.

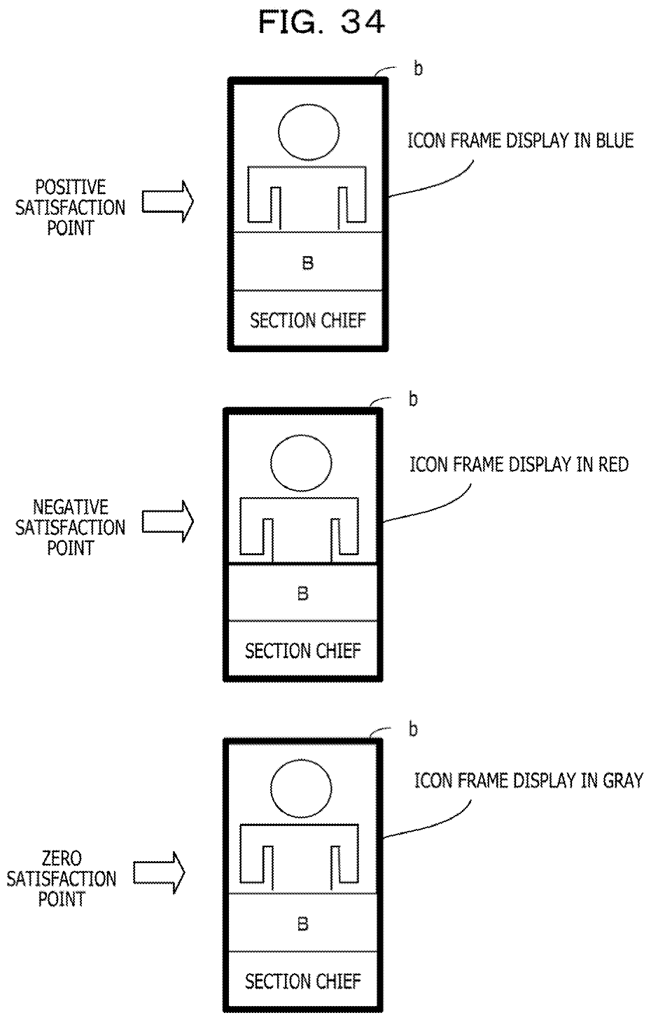

FIG. 34 is a diagram illustrating exemplary display of icon frames of satisfaction levels. The control unit 11 changes the color display of the icon frame of the participant icon on the basis of the satisfaction level obtained in step S25. For example, in a case where the satisfaction point of the participant B is positive, the icon frame of the participant icon b is displayed in blue. In a case where the satisfaction point of the participant B is negative, the icon frame of the participant icon b is displayed in red. In a case where the satisfaction point of the participant B is zero, the icon frame of the participant icon b is displayed in gray. In this manner, the icon frame of the participant icon is variably displayed according to the satisfaction point, whereby the user is enabled to recognize the satisfaction level of the participant easily.

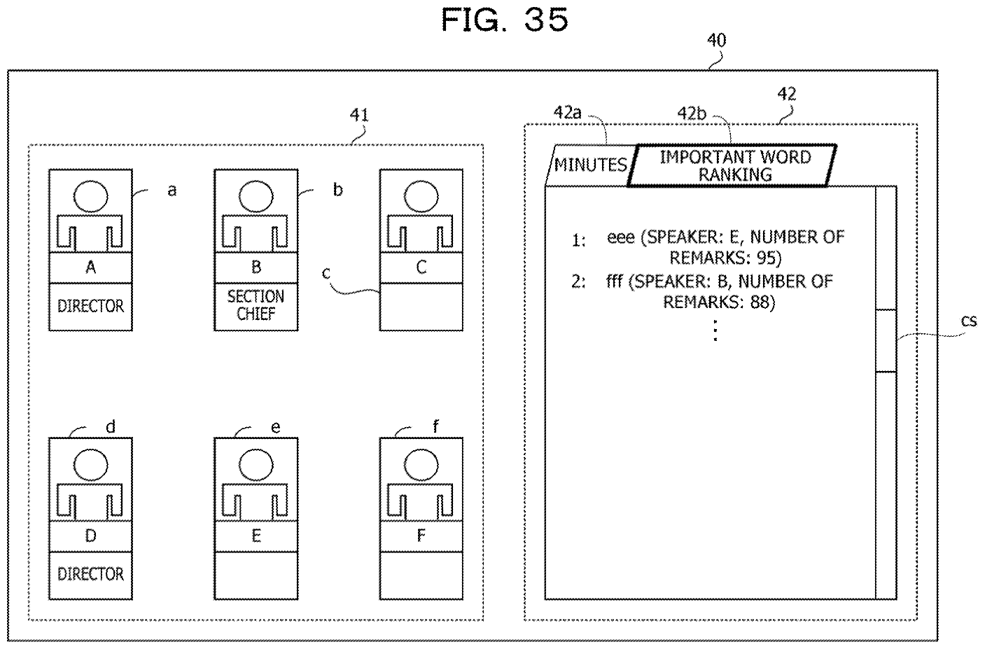

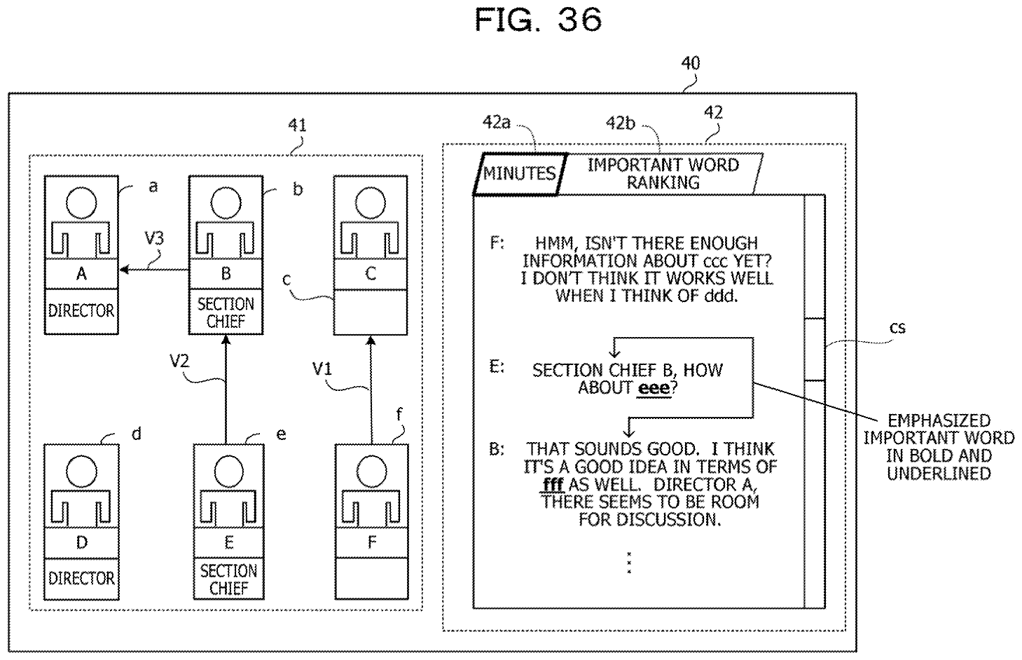

FIGS. 35 and 36 are a diagrams illustrating exemplary display of the important word ranking. In FIG. 35, when the user designates the important word ranking 42b of the minutes information 42, a list of important word rankings is displayed. Higher ranked words are displayed with smaller numbers added thereto. Furthermore, the name of the speaker who has spoken the word and the number of times of speaking may be displayed in the word.

In FIG. 36, for example, high-ranked important words are underlined, or important words are emphasized in bold in the text in the minutes 42a. In this manner, it is also possible to emphasize and display the important words in the minutes 42a so that the user is enabled to recognize them.

As described above, according to the present embodiments, minutes of a conference are generated, a speaking partner of a remark to be recorded in the minutes is identified, and the minutes and a speaking direction from a speaker who has made the remark to the speaking partner are displayed. This makes it possible to visualize the speaking partner of the remark to be recorded in the minutes, whereby a user is enabled to easily recognize to whom the remark in the minutes has been directed.

Furthermore, a satisfaction level, an interest level, and an important word in the minutes are visualized in addition to the speaking direction. As a result, a third part is enabled to visually recognize the conference background and results and the detailed atmosphere of the conference, whereby it becomes possible to better understand the conference contents.

The display control device 1 and the server device 10 according to the present embodiments described above may be constructed by a computer. In this case, a program in which the processing content of the functions of the display control device 1 and server device 10 is described is provided. The program is executed on the computer, whereby the processing functions described above are implemented on the computer.

The program describing the processing content may be recorded on a computer-readable recording medium. Examples of the computer-readable recording medium include a magnetic storage unit, an optical disk, a magneto-optical recording medium, a semiconductor memory, and the like. Examples of the magnetic storage unit include a hard disk drive (HDD), a flexible disk (FD), a magnetic tape, and the like. Examples of the optical disk include a CD-ROM/RW and the like. Examples of the magneto-optical recording medium include a magneto-optical (MO) disk and the like.

In a case of distributing the program, for example, portable recording media such as CD-ROMs in which the program is recorded are sold. Alternatively, it is also possible to store the program in a storage unit of a server computer and transfer the program from the server computer to another computer via a network.

The computer that executes the program stores, for example, the program recorded in the portable reading medium or the program transferred from the server computer in a storage unit of its own. Then, the computer reads the program from the storage unit of its own and executes processing according to the program. Note that the computer may also read the program directly from the portable recording medium and execute processing according to the program.

Furthermore, the computer may also successively execute processing according to the received program each time the program is transferred from the server computer connected via the network. Furthermore, at least a part of the processing functions described above may be implemented by an electronic circuit such as a DSP, an ASIC, or a PLD.

The embodiments have been exemplified above, and the configuration of each unit described in the embodiments may be replaced with another configuration having a similar function. Furthermore, any other components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a display control program for causing a computer to execute a process comprising:
identifying, from voice information of a participant of a conference or image information of the conference stored in a storage unit, a speaking partner of a remark to be recorded in minutes generated on a basis of the voice information; and
displaying the remark to be recorded in the minutes and a relationship between a speaker who has made the remark and the participant other than the speaker in conjunction with each other.

2. The non-transitory computer-readable recording medium storing the display control program according to claim 1, wherein the process displays the remark to be recorded in the minutes and a speaking direction from the speaker who has made the remark to the speaking partner as the relationship in conjunction with each other.

3. The non-transitory computer-readable recording medium storing the display control program according to claim 2, wherein the process generates a participant icon in which the participant is symbolized with a pattern, displays the participant icon in one area of a screen, displays the remark to be recorded in the minutes in another area of the screen, and displays the speaking direction by using an arrow from a first participant icon that represents the speaker toward a second participant icon that represents the speaking partner.

4. The non-transitory computer-readable recording medium storing the display control program according to claim 1, wherein the process is configured to:
obtain the voice information in a time period when the remark to be recorded in the minutes is made, and in a case where a called name is detected in the obtained voice information, identify the participant with the name as the speaking partner; and
obtain the image information in the time period when the remark to be recorded in the minutes is made, detect a line of sight of the speaker from the obtained image information, and identify the participant located in front of the line of sight as the speaking partner.

5. The non-transitory computer-readable recording medium storing the display control program according to claim 3, wherein the process is configured to:
obtain the image information in a time period when the remark to be recorded in the minutes is made and in a predetermined time period that includes a predetermined time before and after the time period, and determine an action of the participant from the obtained image information;
set a satisfaction point in which a satisfaction level of the participant is converted into a number to be positive in a case where an action of the participant is a positive action, set the satisfaction point to be negative in a case where the action of the participant is a negative action, and set the satisfaction point to zero in a case where the action of the participant is neither the positive action nor the negative action;
obtain the voice information in the time period when the remark to be recorded in the minutes is made and in the predetermined time period that includes the predetermined time before and after the time period, and determine content of the remark from the obtained voice information;
set the satisfaction point to be positive in a case where the content of the remark is a positive remark, set the satisfaction point to be negative in a case where the content of the remark is a negative remark, and set the satisfaction point to zero in a case where the content of the remark is neither the positive remark nor the negative remark; and
identify and display an icon frame of the participant icon according to each of the positive, negative, or zero satisfaction point.

6. The non-transitory computer-readable recording medium storing the display control program according to claim 3, wherein the process is configured to:
obtain the voice information in a time period when the remark to be recorded in the minutes is made, and calculate a voice volume point in which voice volume of the participant is converted into a number from the obtained voice information;
calculate a speaking time of the participant in the conference;
perform a voice emotion recognition processing on the obtained voice information to determine an emotion type, and obtain an emotion point to be set to the emotion type;
calculate an interest point in which an interest level of the participant in the remark is converted into a number on a basis of the voice volume point, the speaking time, and the emotion point; and
vary an emphasis level of the arrow display that indicates the speaking direction according to a size of the interest point.

7. The non-transitory computer-readable recording medium storing the display control program according to claim 1, wherein the process is configured to:
weight the participant to set a weight value for each of the participants;
combine a word spoken by the speaker and a number of appearances of the word on a basis of the voice information;
calculate a word point in which an importance level of the word is converted into a number on a basis of a product of the number of appearances of the word and the weight value of the speaker; and
rank and display the importance level of the word on a basis of the word point.

8. The non-transitory computer-readable recording medium storing the display control program according to claim 7, wherein
when the remark to be recorded in the minutes is displayed, a word with the importance level determined to be equal to or higher than a predetermined standard on a basis of the word point is emphasized and displayed.

9. An information processing device comprising:
a memory; and
a computer coupled to the memory and configured to:
identify, from voice information of a participant of a conference or image information of the conference stored in a storage unit, a speaking partner of a remark to be recorded in minutes generated on a basis of the voice information; and
display the remark to be recorded in the minutes and a relationship between a speaker who has made the remark and the participant other than the speaker in conjunction with each other.

10. A display control method comprising:
identifying, by a computer, from voice information of a participant of a conference or image information of the conference stored in a storage unit, a speaking partner of a remark to be recorded in minutes generated on a basis of the voice information; and
displaying the remark to be recorded in the minutes and a relationship between a speaker who has made the remark and the participant other than the speaker in conjunction with each other.
